(19) United States
(12) Patent Application Publication
(10) Pub. No.: US 2026/0194653 A1
(43) Pub. Date: Jul. 9, 2026

(54) DEVICE FOR DETECTING SURROUNDING ENVIRONMENT OF MOVING OBJECT

(71) Applicant: HYUNDAI MOBIS CO., LTD., Seoul (KR)

(72) Inventor: Eun Seok KANG, Yongin-si, (KR)

(73) Assignee: HYUNDAI MOBIS CO., LTD., Seoul (KR)

(21) Appl. No.: 19/413,259

(22) Filed: Dec. 9, 2025

(30) Foreign Application Priority Data
Jan. 9, 2025 (KR) 10-2025-0003510

(51) Int. Cl. G01S 13/931; G01S 13/86; G06V 10/98; G06V 20/58

(52) U.S. Cl. CPC G01S 13/931; G01S 13/867; G06V 10/993; G06V 20/58; G06V 2201/07; G06V 2201/08

(57) ABSTRACT

The present disclosure relates to a device for detecting a surrounding environment of a moving object, and more specifically, to a device for detecting a surrounding environment of a moving object, which can more accurately detect vehicles and the like approaching from the rear and rear side of a moving object using a radar and a camera. The present disclosure is directed to more accurately detecting a rear or rear-side target through comprehensive consideration of detection data generated by a camera device and detection data generated by a radar device.

### CROSS REFERENCE TO RELATED APPLICATION

The present application claims priority to Korean Patent Application No. 10-2025-0003510, filed on January 9, 2025, the entire contents of which is incorporated herein for all purposes by this reference.

### BACKGROUND

### Field

The present disclosure relates to a device for detecting a surrounding environment of a moving object, and more specifically, to a device for detecting a surrounding environment of a moving object, which can more accurately detect vehicles and the like approaching from the rear and rear side of a moving object using a radar and a camera.

### Description of the Related Art

Generally, when driving a vehicle, a driver can easily identify and determine a driving direction, that is, a forward situation, but left and right sides and the rear of the vehicle are blind spots, making identification impossible, and thus in order to address this issue, all vehicles are provided with standard components, such as a room mirror, side mirrors, rearview mirrors, and the like, on inner and outer surfaces of the vehicles.

Meanwhile, these conventional components for securing visibility (such as a room mirror, side mirrors, rearview mirrors, and the like) are formed of typical mirrors that allow the driver to identify objects using light reflection and are each distributed and installed both inside and outside the vehicle.

Accordingly, these conventional components for securing visibility not only cause inconvenience in use, which requires the driver to actively turn his/her head or shift his/her gaze depending on the direction he/she wants to check in order to determine a situation at each position from a distance, but also have structural limitations that, due to a mirror structure that determines objects based on simple light reflection, the clarity and reflection range of a subject is inevitably severely limited, and furthermore, the rear and side blind spots of the vehicle cannot be identified at all using only these conventional components for securing visibility.

Accordingly, recently, as a technology of partially solving the problems of the conventional components for securing visibility, rear-view cameras for a vehicle, which are compatible with dedicated monitors or typical navigation monitors, capture an image of the rear view of the vehicle as one image information, and provide the image information to a driver, have been widely developed and deployed. In addition, a technology of detecting rear obstacles using a radar device and alerting a driver when detecting the rear obstacles is also being installed in vehicles.

However, when a vehicle is close behind, a rear detection camera has a problem that a shadow zone of the camera occurs due to the corresponding vehicle, and the camera cannot detect the vehicle approaching from the rear side due to the shadow zone. In addition, there is a problem that a rear detection radar can detect a ghost target different from an actual detection target due to multiple reflections of the actual vehicle when guardrails are present alongside lanes depending on a road environment.

### SUMMARY

The present disclosure is intended to solve the above problems and is directed to more accurately detecting a rear or rear-side target through comprehensive consideration of detection data generated by a camera device and detection data generated by a radar device.

According to one aspect of the present disclosure, there is provided a device for detecting a surrounding environment of a moving object, including a data reception module that receives radar detection information and image information, and a detection information output module that provides surrounding environment detection information based on at least one of the radar detection information and the image information.

According to an embodiment, the detection information output module may output a detected target included both in the radar detection information and the image information as the surrounding environment detection information.

According to an embodiment, when a target is detected from only one of the radar detection information and the image information, the detection information output module may determine whether the detected target is valid information based on the surrounding environment detection information generated for a predetermined time.

According to an embodiment, the detection information output module may detect a degradation factor included in the surrounding environment detection information generated for the predetermined time to determine whether the detected target is valid information based on the detected degradation factor.

According to an embodiment, when the target is detected from only the radar detection information, the detection information output module may determine whether the detected target is valid information based on at least one of camera shadow information and guardrail information included in the degradation factor.

According to an embodiment, when the target detected from the radar detection information is included within a camera shadow zone based on the camera shadow information, the detection information output module may output the surrounding environment detection information based on the radar detection information.

According to an embodiment, the detection information output module may determine that the detected target is invalid information based on the guardrail information when the detected target is positioned between the moving object and a guardrail and is positioned at a distance larger than a distance between the moving object and an actual target.

According to an embodiment, when it is determined that the detected target is invalid information based on the guardrail information, the detection information output module outputs rear-side detection information based on the image information.

According to an embodiment, when the target detected from the radar detection information is included within a camera shadow zone based on the camera shadow information and the detected target is estimated to be invalid information based on the guardrail information, the detection information output module may not output the surrounding environment detection information until the detected target leaves the shadow zone.

According to an embodiment, when the detected target leaves the shadow zone and comes within a predetermined distance from the moving object, the detection information output module may output the surrounding environment detection information.

### BRIEF DESCRIPTION OF THE DRAWINGS

FIG. 1 is a block diagram showing a device for detecting a surrounding environment of a moving object according to an embodiment of the present disclosure.

FIG. 2 is an exemplary view showing detection of a detection target in a shadow zone of the device for detecting a surrounding environment of a moving object according to the embodiment of the present disclosure.

FIG. 3 is an exemplary view showing a method of determining the validity of a detection target, which is performed by the device for detecting a surrounding environment of a moving object according to the embodiment of the present disclosure.

FIG. 4 is an exemplary view showing a method of determining the validity of a detection target in the shadow zone of the device for detecting a surrounding environment of a moving object according to the embodiment of the present disclosure.

### DETAILED DESCRIPTION

The above-described purpose, features, and advantages of the present disclosure will become clearer through the following embodiments in conjunction with the attached drawings. The following specific structural and functional descriptions are merely illustrative for the purpose of describing embodiments according to the concept of the present disclosure, and the embodiments according to the concept of the present disclosure may be implemented in various forms and should not be construed as limited to embodiments in the specification or the application. Since the embodiments according to the concept of the present disclosure may be variously changed and may have various forms, specific embodiments will be illustrated in the drawings and described in detail in the specification or the application. However, it should be understood that this is not intended to limit the embodiments according to the concept of the present disclosure to a specific form and includes all changes, equivalents, and substitutions included within the spirit and technical scope of the present disclosure. The terms such as first and/or second may be used to describe various components, but the components are not limited by the terms. The terms are used only for the purpose of distinguishing one component from another, and for example, a first component may be referred to as a second component, and similarly, the second component may also be referred to as the first component without departing from the scope according to the concept of the present disclosure. It should be understood that when a first component is described as being “connected” or “coupled” to a second component, the first component may be directly connected or coupled to the second component, but a third component may also be present therebetween. On the other hand, it should be understood that when a first component is described as being “directly connected” or “directly coupled” to a second component, a third component is not present therebetween. Other expressions for describing the relationship between components, such as “between” and “directly between” or “adjacent to” and “directly adjacent to” should be construed in the same manner. The terms used in the specification are only used to describe specific embodiments and are not intended to limit the present disclosure. The singular includes the plural unless the context clearly dictates otherwise. In the specification, it should be understood that the term “comprise” or “have” is intended to specify that a stated feature, number, step, operation, component, part, or a combination thereof is present and does not preclude the possibility of the presence or addition of one or more other features, numbers, steps, operations, components, parts, or combinations thereof. Unless defined otherwise, all terms used herein, including technical or scientific terms, have the same meaning as commonly understood by those of ordinary skill in the art to which the present disclosure pertains. The terms defined in a generally used dictionary should be construed as having meanings that coincide with the meanings of the terms from the context of the related technology and are not construed as an ideal or excessively formal meaning unless clearly defined in the specification. Hereinafter, the present disclosure will be described in detail by describing preferred embodiments of the present disclosure with reference to the accompanying drawings. The same reference numerals in each drawing indicate the same member.

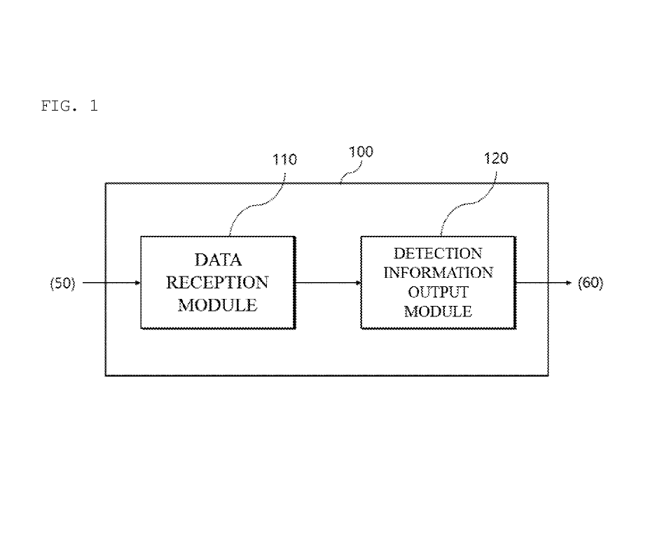

FIG. 1 is a block diagram showing a device for detecting a surrounding environment of a moving object according to an embodiment of the present disclosure.

Referring to FIG. 1, a device 100 for detecting a surrounding environment of a moving object according to an embodiment of the present disclosure may include a data reception module 110 and a detection information output module 120. Here, the data reception module 110 may receive detection information from an external device 50 included in the moving object. The external device 50 may include, for example, a camera and a radar device. In addition, the detection information output module 120 may output surrounding environment detection information to a main control device or an information providing device 60 within the moving object in order to provide a user with the surrounding environment detection information. The information providing device 60 may be controlled by the main control device or may output the surrounding environment detection information through sound or a display device.

The data reception module 110 may receive radar detection information and image information from the external device 50. The data reception module 110 may transmit the received radar detection information and image information to the detection information output module 120.

The detection information output module 120 may output the surrounding environment detection information based on at least one of the radar detection information and the image information. The surrounding environment detection information may include, for example, rear or rear-side obstacle (vehicle) detection information. In addition, the detection information output module 120 may collect the radar detection information and the image information and output a detection target included in both the radar detection information and the image information as the surrounding environment detection information. For example, when a vehicle positioned behind a moving object is included in both the image information and the radar detection information, the detection information output module 120 may output the corresponding vehicle as the surrounding environment detection information.

In addition, when a target is detected from only one of the radar detection information and the image information, the detection information output module 120 may generate the surrounding environment detection information for a predetermined time to determine whether the detected target is valid. For example, the detection information output module 120 may detect degradation factors in the surrounding environment detection information generated for the predetermined time to determine whether the detected target is valid. The degradation factors may include camera shadow information, guardrail information, etc.

When a target is detected from only the radar detection information, the detection information output module 120 may determine whether the detected target is valid based on at least one of the camera shadow information and the guardrail information included in the degradation factors. For example, when the target detected from the radar detection information is within a camera shadow zone based on the camera shadow information, the detection information output module 120 may output the surrounding environment detection information based on the radar detection information.

In addition, Radar detection information may include a ghost target that is detected due to multiple reflections of an actual target off guardrails. In order to prevent this, the detection information output module 120 may determine that the detected target is invalid based on guardrail information when the detected target is positioned between the moving object and the guardrail and is positioned at a distance larger than a distance between the moving object and the actual target. In this case, when the detection information output module 120 determines that the detected target is invalid based on the guardrail information, the detection information output module 120 may output the surrounding environment detection information based on the image information.

In addition, the detection information output module 120 may not output the surrounding environment detection information until the detected target leaves the shadow zone when the target detected from the radar detection information is included within the camera shadow zone based on the camera shadow information and the detected target is estimated to be invalid based on the guardrail information. That is, when a ghost target is detected in the shadow zone, the detection information output module 120 may gradually increase a confidence value as the detected target moves toward the moving object and output the surrounding environment detection information when the confidence value is a predetermined confidence value or more. In addition, the detection information output module 120 may output the identified detected target as the surrounding environment detection information when the detected target leaves the shadow zone and becomes identifiable.

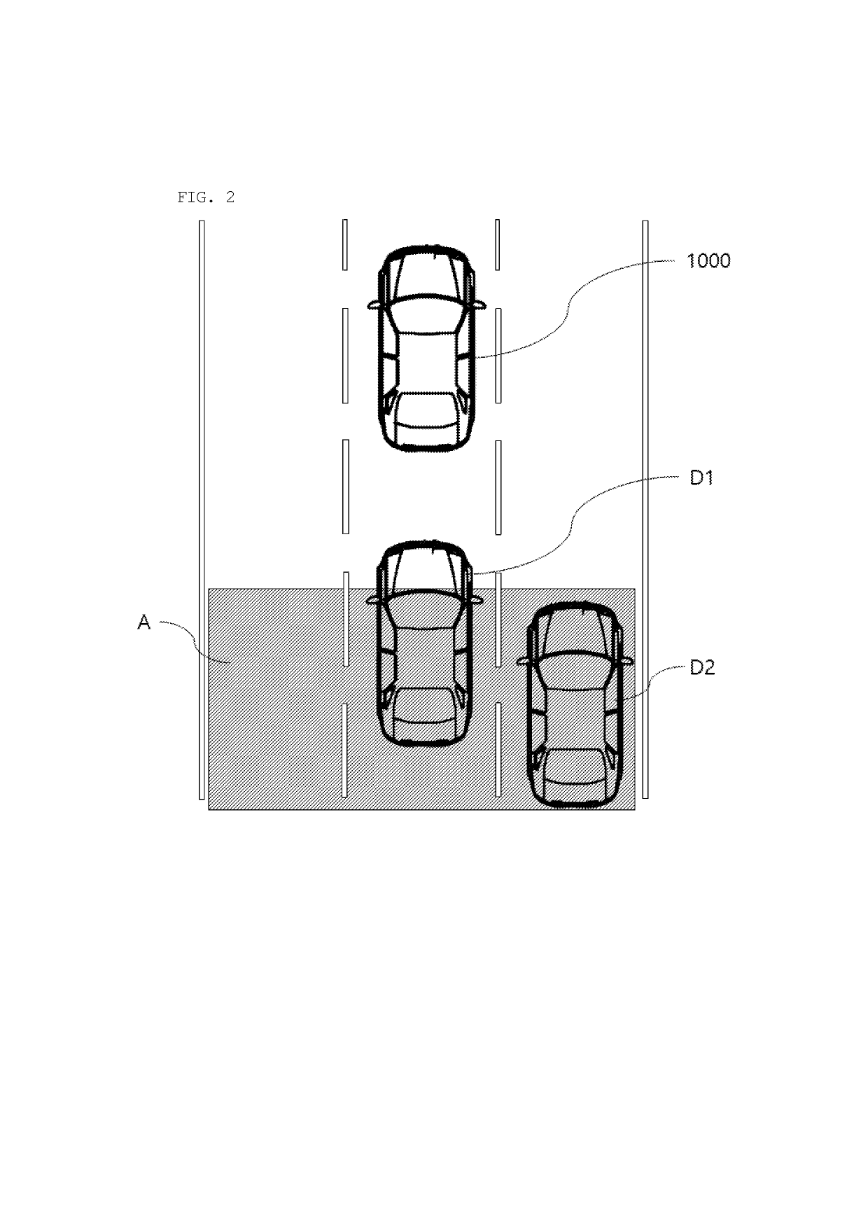

FIG. 2 is an exemplary view showing detection of a detection target in a shadow zone of the device for detecting a surrounding environment of a moving object according to the embodiment of the present disclosure.

Referring to FIG. 2, a shadow zone A may be formed by a rear obstacle D1 of a camera device included in a moving object 1000. In this case, the camera device included in the moving object 1000 has difficulty detecting a rear-side obstacle D2. The surrounding environment detection device 100 of a moving object according to the present disclosure may detect the rear-side obstacle D2 positioned within the shadow zone A using the radar detection information generated by the radar device in addition to the image information.

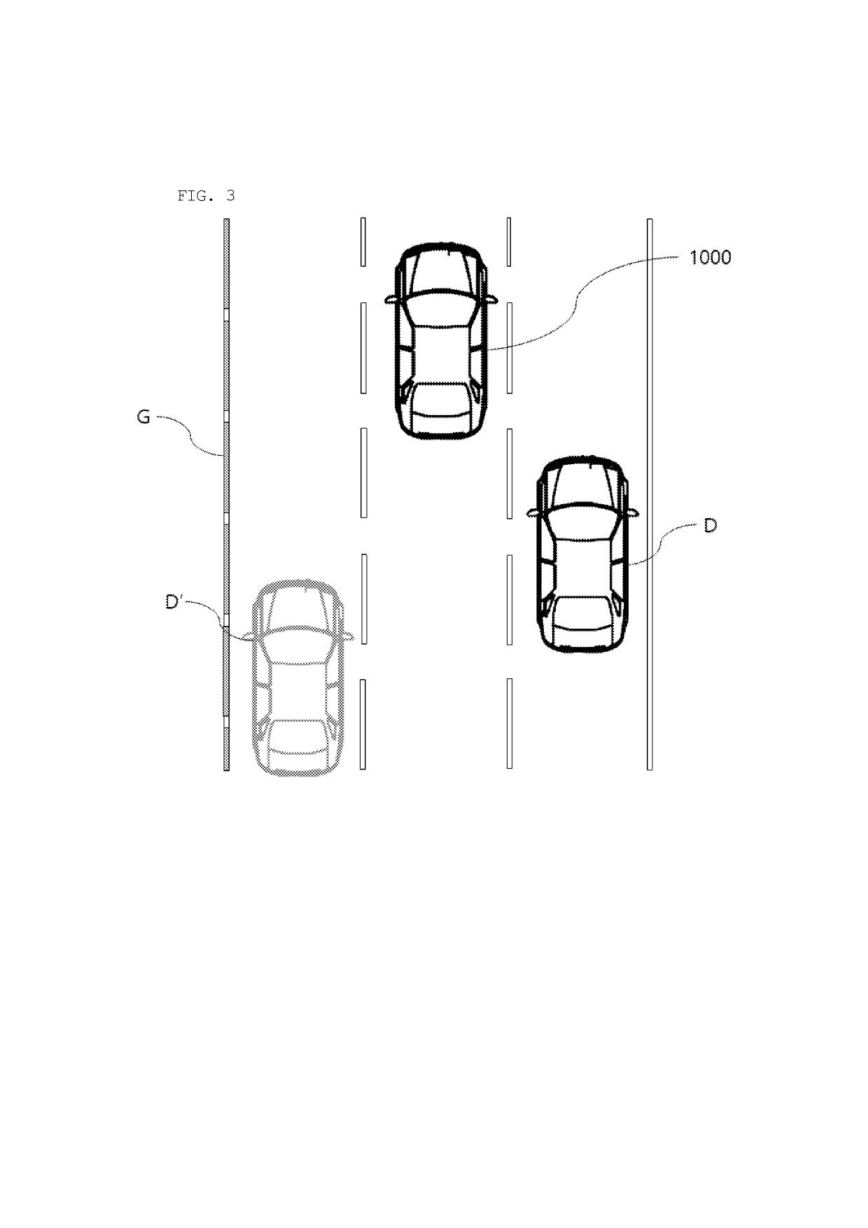

FIG. 3 is an exemplary view showing a method of determining the validity of a detection target, which is performed by the device for detecting a surrounding environment of a moving object according to the embodiment of the present disclosure.

Referring to FIG. 3, the radar device included in the moving object 1000 may detect a ghost target D’ due to multiple reflections from an actual target D and a guardrail G. In this case, the surrounding environment detection device 100 may determine the validity of the ghost target D’ using the image information, and when it is determined that the ghost target D’ is invalid, the surrounding environment detection device 100 may remove the detected ghost target D’ and output the surrounding environment detection information. In addition, the detection information output module 120 may determine that the ghost target D’ is invalid based on the guardrail information when the ghost target D’ is positioned between the moving object 1000 and the guardrail G and is positioned at a distance larger than a distance between the moving object 1000 and the actual target D. In this case, when it is determined that the detected target is the ghost target D’ based on the guardrail information, the detection information output module 120 may output the surrounding environment detection information based on the image information.

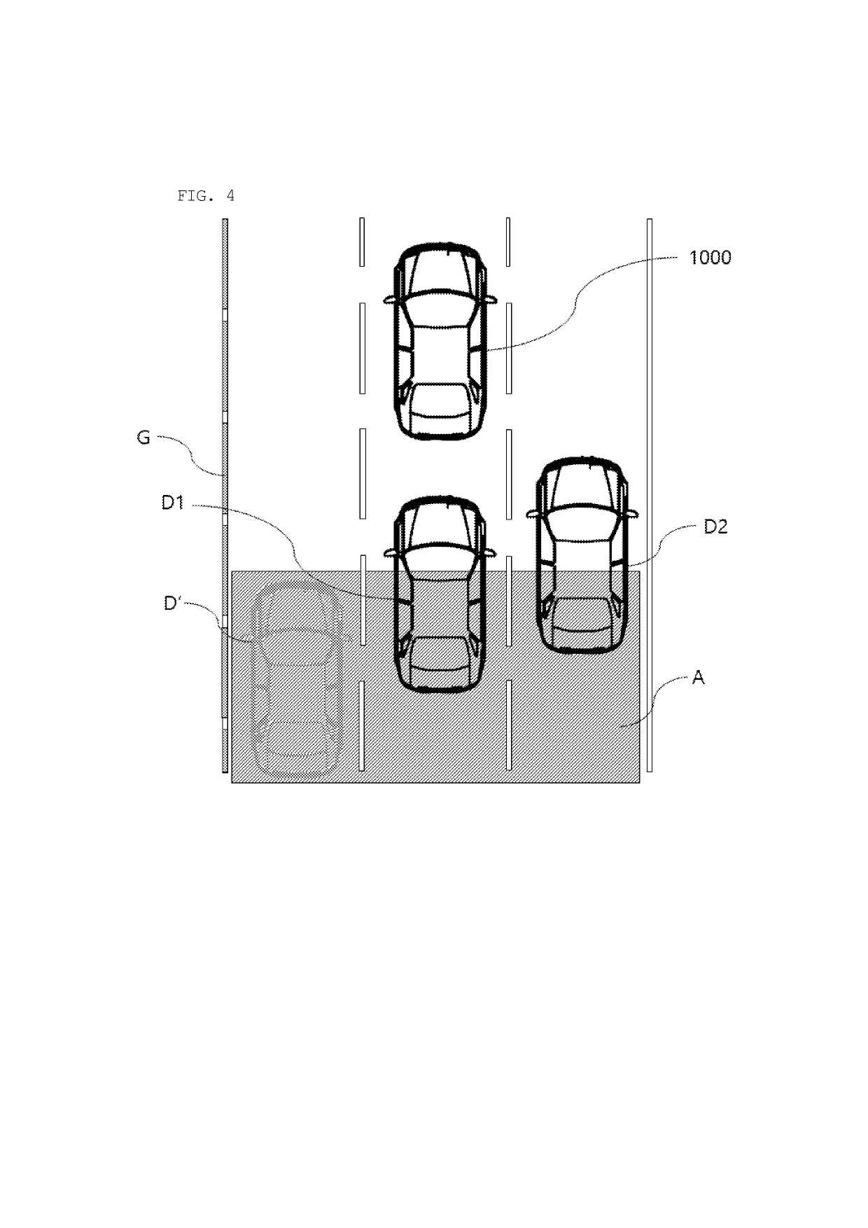

FIG. 4 is an exemplary view showing a method of determining the validity of a detection target in the shadow area of the device for detecting a surrounding environment of a moving object according to the embodiment of the present disclosure.

Referring to FIG. 4, a camera device included in the moving object 1000 have the shadow zone A generated due to the rear obstacle D1, and a radar device included in the moving object 1000 may detect the ghost target D’ generated due to multiple reflections of an actual target D2 and the guardrail G. At this time, the ghost target D’ may be detected within the shadow zone A.

In this case, when the target detected from the radar detection information based on the camera shadow information is included within the camera shadow zone A and the detected target is estimated to be the ghost target D’ based on the guardrail information, the surrounding environment detection device 100 of the moving object may not output the surrounding environment detection information until the detected target leaves the shadow zone A. That is, when the ghost target D’ is detected from the shadow zone A, the surrounding environment detection device 100 of the moving object may gradually increase the confidence value as the detected target moves toward the moving device and output the surrounding environment detection information when the confidence value is a predetermined confidence value or more. In addition, the surrounding environment detection device 100 of the moving object may output the identified detected target as the surrounding environment detection information when the detected target leaves the shadow zone and becomes identifiable.

According to the present disclosure, it is possible to more accurately detect obstacles positioned at the rear or rear side using both image information and radar detection information.

In addition, even when the shadow zone of the camera device is generated by the following vehicle, obstacles positioned in the shadow zone can be detected.

In addition, according to the present disclosure, by evaluating the reliability of ghost targets caused by multiple reflections from road degradation factors, it is possible to more accurately determine the validity of detected obstacles.

In addition, according to the present disclosure, since the validity of the detection target is determined based on reliability, it is possible to more accurately detect obstacles by enhancing the reliability of the detection target.

Although the exemplary embodiments of the present disclosure have been described above, the embodiments disclosed in the present disclosure are not intended to limit the technical spirit of the present disclosure but are only for description. Accordingly, the technical spirit of the present disclosure includes not only each disclosed embodiment, but also a combination of the disclosed embodiments, and furthermore, the scope of the technical spirit of the present disclosure is not limited by these embodiments. In addition, those skilled in the art to which the present disclosure pertains can variously change and modify the present disclosure without departing from the spirit and scope of the appended claims, and all such appropriate changes and modifications should be regarded as belonging to the scope of the present disclosure as equivalents. In addition, the upward and downward directions disclosed in the present disclosure are only directions of upper and lower electrodes, respectively, and are not necessarily up and down directions.

### DESCRIPTION OF REFERENCE NUMERALS

50: external device

60: information providing device

100: surrounding environment detection device

110: data reception module

120: detection information output module

1000: moving object

A: shadow zone

G: guardrail

What is claimed is:

1. A device for detecting a surrounding environment of a moving object, comprising:
a data reception module configured to receive radar detection information and image information; and
a detection information output module configured to provide surrounding environment detection information based on at least one of the radar detection information and the image information.

2. The device of claim 1, wherein the detection information output module is configured to provide the surrounding environment detection information about a same detection target included in both the radar detection information and the image information.

3. The device of claim 2, wherein, in response to a detected target is detected from only one of the radar detection information and the image information, the detection information output module is configured to determine whether the detected target is valid based on the surrounding environment detection information generated for a predetermined time.

4. The device of claim 3, wherein the detection information output module is configured to detect a degradation factor included in the surrounding environment detection information generated for the predetermined time to determine whether the detected target is valid based on the degradation factor.

5. The device of claim 4, wherein, in response to the detected target is detected from only the radar detection information, the detection information output module is configured to determine whether the detected target is valid based on at least one of camera shadow information and guardrail information included in the degradation factor.

6. The device of claim 5, wherein, in response to the detected target detected from the radar detection information is included within a camera shadow zone based on the camera shadow information, the detection information output module is configured to output the surrounding environment detection information based on the radar detection information.

7. The device of claim 5, wherein the detection information output module is configured to determine that the detected target is invalid based on the guardrail information in response to the detected target is positioned between the moving object and a guardrail and is positioned at a first distance larger than a second distance between the moving object and an actual target.

8. The device of claim 7, wherein, in response to the detected target is determined to be invalid based on the guardrail information, the detection information output module is configured to output the surrounding environment detection information based on the image information.

9. The device of claim 7, wherein, in response to the detected target detected from the radar detection information is included within a camera shadow zone based on the camera shadow information and the detected target is estimated to be invalid based on the guardrail information, the detection information output module is configured not to output the surrounding environment detection information until the detected target leaves the shadow zone.

10. The device of claim 9, wherein, in response to the detected target leaves the shadow zone and comes within a predetermined distance from the moving object, the detection information output module is configured to output the surrounding environment detection information.
